(19) United States
(12) Patent Application Publication
(10) Pub. No.: US 2019/0325471 A1
(43) Pub. Date: Oct. 24, 2019

(54) INFORMATION PROCESSING SYSTEM, INFORMATION PROCESSING APPARATUS, AND NON-TRANSITORY COMPUTER READABLE MEDIUM

(71) Applicant: FUJI XEROX CO., LTD., Tokyo (JP)

(72) Inventor: Kenji AKIBA, Kanagawa (JP)

(73) Assignee: FUJI XEROX CO., LTD., Tokyo (JP)

(21) Appl. No.: 16/383,676

(22) Filed: Apr. 15, 2019

(30) Foreign Application Priority Data
Apr. 23, 2018 (JP) 2018-082381

(51) Int. Cl. G06Q 30/02

(52) U.S. Cl. CPC G06Q 30/0224; G06Q 30/0235

(57) ABSTRACT

An information processing system includes a collector that collects, from a terminal apparatus of a customer, operating information related to an operation of a function of a product contracted by the customer and used on the terminal apparatus, a specification unit that specifies a usage condition of the product on a basis of the collected operating information, and a creator that creates proposal information related to a proposal regarding usage of the product to the customer, on a basis of the usage condition.

### CROSS-REFERENCE TO RELATED APPLICATIONS

This application is based on and claims priority under 35 USC 119 from Japanese Patent Application No. 2018-082381 filed Apr. 23, 2018.

### BACKGROUND

### (i) Technical Field

The present disclosure relates to an information processing system, an information processing apparatus, and a non-transitory computer readable medium.

### (ii) Related Art

For example, Japanese Unexamined Patent Application Publication No. 2002-334201 describes a business support method that reveals customers with latent demand by extracting customers for which at least one demand from among a cross-sell, up-sell, and replacement purchase of a new product is recognized on the basis of at least one of the properties of products and relationships between products, and a purchase history of products by the customer, and causing the extracted customers to be displayed on a screen.

### SUMMARY

Marketing that takes into account a new contract for a product is known, for example. However, with the techniques of the related art, for products already contracted by a customer, proposals to the customer regarding the usage of the product are insufficient.

Aspects of non-limiting embodiments of the present disclosure relate to making proposals regarding the usage of a product to a customer after a product contract has been made.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a collector that collects, from a terminal apparatus of a customer, operating information related to an operation of a function of a product contracted by the customer and used on the terminal apparatus, a specification unit that specifies a usage condition of the product on a basis of the collected operating information, and a creator that creates proposal information related to a proposal regarding usage of the product to the customer, on a basis of the usage condition.

### BRIEF DESCRIPTION OF THE DRAWINGS

An exemplary embodiment of the present disclosure will be described in detail based on the following figures, wherein:

FIG. 1 is an overall diagram illustrating an example of an information processing system according to the present exemplary embodiment;

FIG. 2 is a diagram illustrating a functional configuration of a customer terminal apparatus according to the present exemplary embodiment;

FIG. 3 is a diagram illustrating a functional configuration of a server apparatus according to the present exemplary embodiment;

FIG. 4 is a diagram illustrating an example of a collected information list according to the present exemplary embodiment;

FIG. 5 is a diagram illustrating an example of customer contract information according to the present exemplary embodiment;

FIG. 6 is a diagram illustrating an example of product information according to the present exemplary embodiment;

FIGS. 7A and 7B are diagrams illustrating an example of topic extraction information and topic/proposal combination information according to the present exemplary embodiment;

FIGS. 8A and 8B are diagrams illustrating an example of a topic template list and a proposal content template list according to the present exemplary embodiment;

FIG. 9 is an example of an operational flowchart of the customer terminal apparatus according to the present exemplary embodiment;

FIG. 10 is an example of an operational flowchart of the server apparatus according to the present exemplary embodiment;

FIGS. 11A and 11B are explanatory diagrams regarding the computation of a product usage frequency according to the present exemplary embodiment;

FIGS. 12A, 12B, and 12C are explanatory diagrams regarding the computation of a product usage frequency according to the present exemplary embodiment; and

FIG. 13 is an explanatory diagram of a specific example of topic and proposal content according to the present exemplary embodiment.

### DETAILED DESCRIPTION

Hereinafter, exemplary embodiments for carrying out the present disclosure will be described with reference to the attached drawings.

[Information Processing System 1]

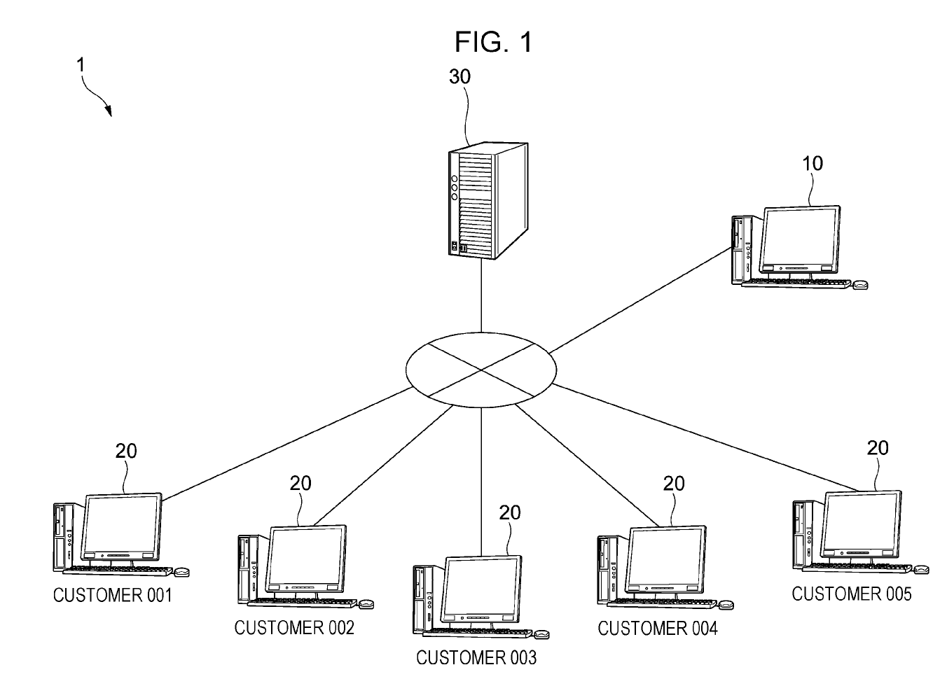

FIG. 1 is an overall diagram illustrating an example of an information processing system 1 according to the present exemplary embodiment.

As illustrated in FIG. 1, the information processing system 1 according to the present exemplary embodiment is provided with a user terminal apparatus 10 that executes information processing, multiple customer terminal apparatus 20 that execute information processing, and a server apparatus 30 that communicates information at least with the customer terminal apparatus 20 and the user terminal apparatus 10 while also executing information processing. Additionally, in the information processing system 1, the customer terminal apparatus 20, the user terminal apparatus 10, and the server apparatus 30 are communicably interconnected through a network.

Note that the network is not particularly limited insofar as the network is a communication network used to communicate data among apparatus, and may be a local area network (LAN), a wide area network (WAN), the Internet, or the like, for example. The communication link used for data communication may be wired, wireless, or a combination of the two. Also, each apparatus may use a relay apparatus such as a gateway apparatus or a router to connect through multiple networks and communication links.

Also, in the present exemplary embodiment, five customer terminal apparatus 20 are connected to the server apparatus 30 through a network. These five customer terminal apparatus 20 are used by five respectively different customers (corresponding to customer code “001” to customer code “005” described later). Also, the present exemplary embodiment is described using a case in which a single customer uses a single customer terminal apparatus 20.

Note that the number of customer terminal apparatus 20 is not limited to the example in the present exemplary embodiment. Furthermore, a single customer may also use multiple customer terminal apparatus 20.

Moreover, although a single server apparatus 30 is illustrated, the server apparatus 30 is not limited to a lone server machine. The server apparatus 30 may also be distributed across multiple server machines provided on a network to achieve the functions of the server apparatus 30 (what is called a cloud environment or the like).

Additionally, the following description uses an example of applying the information processing system 1 to a system used by a sales manager (hereinafter, the user) of a sales corporation that sells products (including goods and services), for example, to a contracting corporation (hereinafter, the customer) with which a contract such as a purchase contract or lease contract for a product from the sales corporation is made, in which the system is used to support the creation of a proposal document for making a proposal to the customer after a contract has been made.

Note that in the present exemplary embodiment, the proposal document may be created in a format that is displayable or the like by document creation software or presentation software, and in various file formats such as Portable Document Format (PDF) or HTML format.

Herein, an overview of the information processing system 1 according to the present exemplary embodiment will be described.

In the information processing system 1, operating information related to the operation of the functions of a product, such as software contracted by the customer for use on the customer terminal apparatus 20, is acquired from the customer terminal apparatus 20. Also, on the basis of the acquired operating information, the information processing system 1 specifies product usage conditions, such as the usage frequency of the product. Additionally, on the basis of the usage conditions, the information processing system 1 creates a proposal document related to a proposal regarding the usage of the product to the customer.

Hereinafter, the information processing system 1 according to the present exemplary embodiment will be described in detail.

(User Terminal Apparatus 10)

The user terminal apparatus 10 is an apparatus that receives the input of information from the user, and presents information to the user by displaying the information on a screen. For the user terminal apparatus 10, stationary terminal equipment such as a desktop PC, mobile terminal equipment that is portable by the user such as a tablet-style terminal, or the like may be used, for example.

Also, in the present exemplary embodiment, the user terminal apparatus 10 is able to communicate with an image forming apparatus that forms (prints) and output an image on a recording medium such as paper using image forming material on the basis of print data acquired from the user terminal apparatus 10.

(Customer Terminal Apparatus 20)

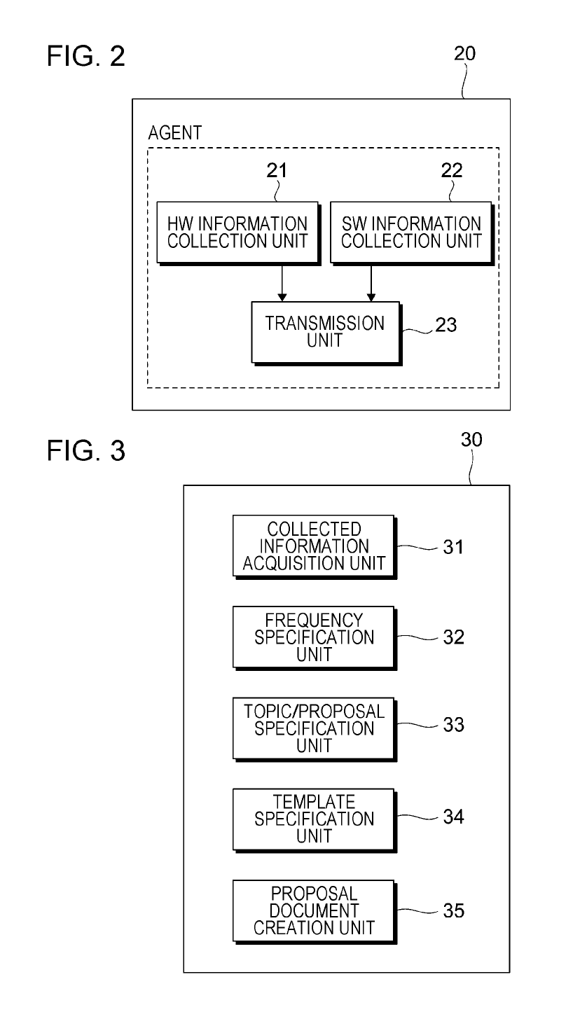

FIG. 2 is a diagram illustrating a functional configuration of the customer terminal apparatus 20 according to the present exemplary embodiment.

The customer terminal apparatus 20 is used by the customer, and is an apparatus that receives the input of information from the customer, and presents information to the customer by displaying the information on a screen. For the customer terminal apparatus 20, stationary terminal equipment such as a desktop PC, mobile terminal equipment that is portable by the user such as a tablet-style terminal, or the like may be used, for example.

Additionally, as illustrated in FIG. 2, the customer terminal apparatus 20 includes a hardware (HW) information collection unit 21 that collects configuration information regarding the HW configuration, a software (SW) information collection unit 22 (one example of a collector) that collects operating information regarding the operation of SW, and a transmission unit 23 that transmits information to the server apparatus 30.

Note that in the present exemplary embodiment, the functions of the HW information collection unit 21, the SW information collection unit 22, and the transmission unit 23 are realized by installing agent software that exhibits these functions in the customer terminal apparatus 20.

(HW Information Collection Unit 21)

The HW information collection unit 21 references a system command or the like of the operating system (OS) in the customer terminal apparatus 20, and collects the host name of the customer terminal apparatus 20. For example, in the case in which Windows (registered trademark) OS is installed, the HW information collection unit 21 collects the host name on the basis of the “systeminfo” command.

Subsequently, the HW information collection unit 21 sends the collected host name information to the transmission unit 23.

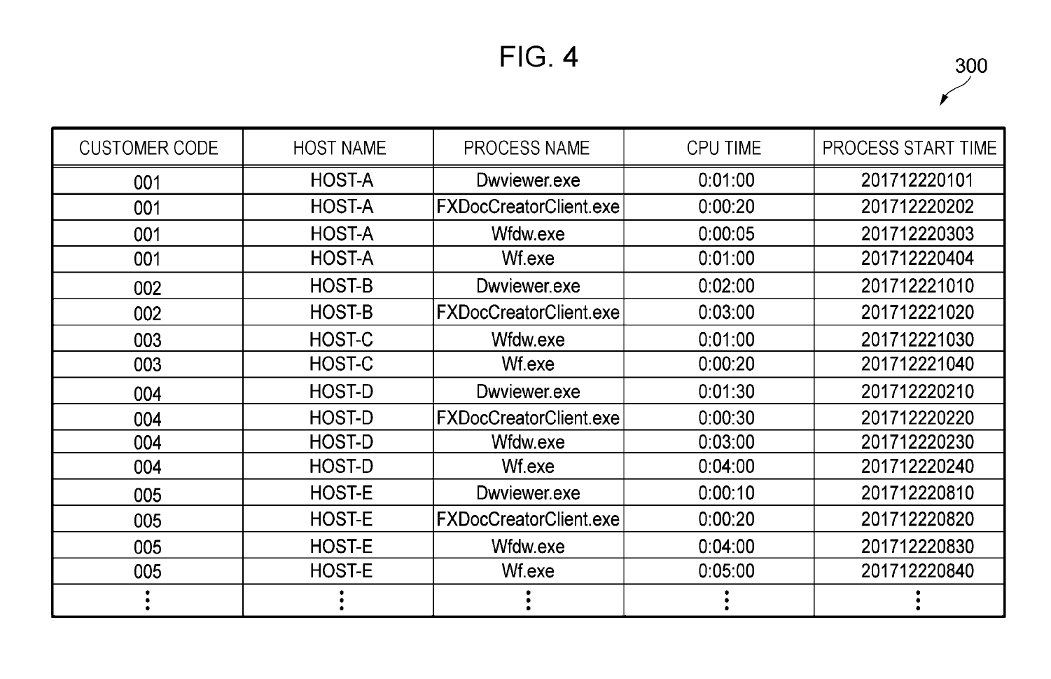

In the present exemplary embodiment, the HW information collection unit 21 of the customer terminal apparatus 20 for each customer collects the host name of each customer terminal apparatus 20. Specifically, in the customer terminal apparatus 20 with the customer code “001”, “HOST-A” is collected as the host name. In the customer terminal apparatus 20 with the customer code “002”, “HOST-B” is collected as the host name. In the customer terminal apparatus 20 with the customer code “003”, “HOST-C” is collected as the host name. In the customer terminal apparatus 20 with the customer code “004”, “HOST-D” is collected as the host name. In the customer terminal apparatus 20 with the customer code “005”, “HOST-E” is collected as the host name (see FIG. 4 described later).

(SW Information Collection Unit 22)

The SW information collection unit 22 references a system command or the like of the operating system (OS) of the customer terminal apparatus 20, and collects information about each of process names (image names), CPU times, and process start times. For example, in the case in which Windows (registered trademark) OS is installed, the SW information collection unit 22 collects processes names and CPU times on the basis of the “tasklist /v” command. Also, the SW information collection unit 22 collects process start times on the basis of the “wmic process” command.

Subsequently, the SW information collection unit 22 sends the collected information about process names, CPU times, and process start times to the transmission unit 23.

Herein, the process name is the name of, for example, a program executed as a process (a unit of execution of a program processed by the CPU, or a unit of management in memory). Consequently, process names are revealed by processes being run on the customer terminal apparatus 20. Also, a CPU time is the duration from the start to the end of the execution of, for example, a program executed as a process. Also, the process start time is the execution start time of each process. Note that the process name, CPU time, and process start time are managed in association with each other as a single unit from the start to the end of the execution of a certain process.

(Transmission Unit 23)

The transmission unit 23 associates the customer codes with the host names acquired from the HW information collection unit 21. The customer code is embedded into the agent software in advance, and is preset for each customer. Note that the customer code is information that uniquely identifies a customer.

Additionally, the transmission unit 23 transmits collected information associating the customer code with the hardware configuration information and the software operating information to the server apparatus 30.

(Server Apparatus 30)

FIG. 3 is a diagram illustrating a functional configuration of the server apparatus 30 according to the present exemplary embodiment.

As illustrated in FIG. 3, the server apparatus 30 is provided with a collected information acquisition unit 31 that acquires the collected information, a frequency specification unit 32 that specifies a product usage frequency (one example of a specification unit), and a topic/proposal specification unit 33 that specifies a customer topic and proposal content on the basis of the product usage frequency. Also, the server apparatus 30 is provided with a template specification unit 34 that specifies templates for the topic and the proposal content, and a proposal document creation unit 35 (one example of a creator) that creates a proposal document for a customer.

(Collected Information Acquisition Unit 31)

FIG. 4 is a diagram illustrating an example of a collected information list 300 according to the present exemplary embodiment.

The collected information acquisition unit 31 acquires the hardware configuration information and software operating information (collected information) associated with the customer code from each customer terminal apparatus 20. Additionally, the collected information acquired from all customer terminal apparatus 20 is managed as a collected information list 300.

As illustrated in FIG. 4, the collected information list 300 is provided with a “Customer Code” field that indicates the customer code, a “Host Name” field that indicates the host name, a “Process Name” field that indicates the process name, a “CPU Time” field that indicates the CPU time, and a “Process Start Time” field that indicates the process start time.

For example, the various information of the host name “HOST-A”, the process name “Dwviewer.exe”, the CPU time “0:01:00”, and the process start time “201712220101” is managed in association with the customer code “001”.

(Frequency Specification Unit 32)

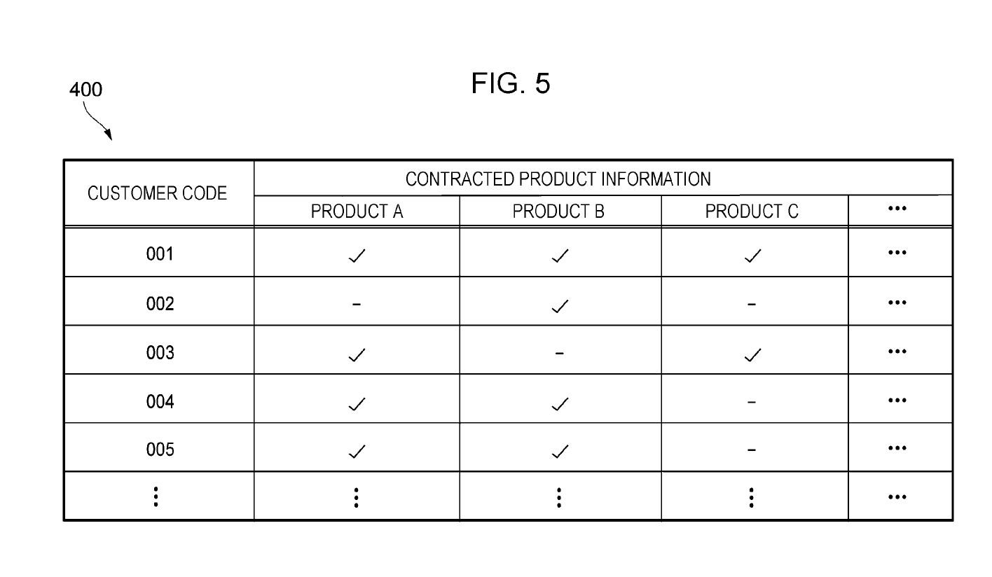

FIG. 5 is a diagram illustrating an example of customer contract information 400 according to the present exemplary embodiment.

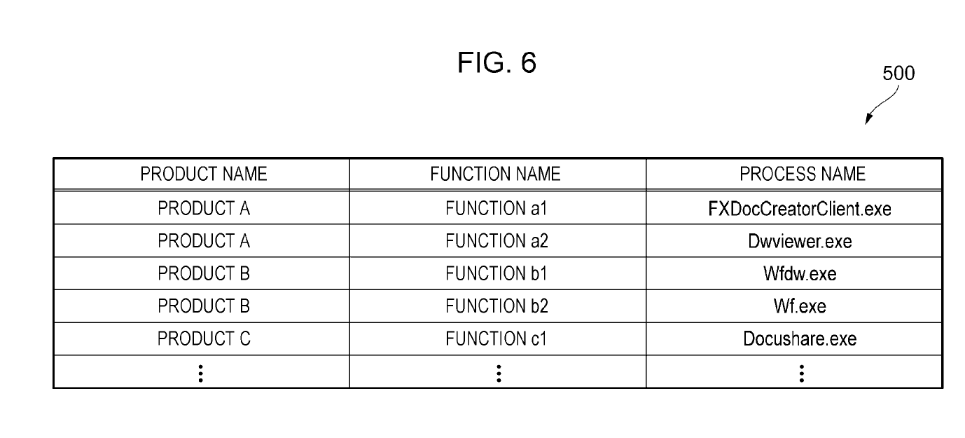

FIG. 6 is a diagram illustrating an example of product information 500 according to the present exemplary embodiment.

The frequency specification unit 32 computes the usage frequency of a product as one example of product usage conditions, on the basis of the collected information stored by the collected information acquisition unit 31. The frequency specification unit 32 ultimately computes the usage frequency for each customer and each product. In the present exemplary embodiment, when computing the product usage frequency, the frequency specification unit 32 specifies an average use time for each function of the product on all of the multiple customer terminal apparatus 20 connected to the network. Additionally, the frequency specification unit 32 specifies a use time for each function of the product for each customer. Subsequently, by comparing the average use time for each function of the product overall and the use time of each function of the product for each customer, the frequency specification unit 32 measures the usage frequency of the function of the product by the customer.

Subsequently, the frequency specification unit 32 sends information about the computed usage frequency level of the product to the topic/proposal specification unit 33.

In the present exemplary embodiment, to compute the product usage frequency, the frequency specification unit 32 stores customer contract information 400 regarding contracts with customers and product information 500 regarding products handled by the sales corporation of the user.

The customer contract information 400 is provided with a “Customer Code” field and a “Contracted Product Information” field regarding contracted products. The contracted product information is information indicating multiple products handled by the sales corporation of the user. In this example, a software product called “Product A”, a service product called “Product B”, and a service product called “Product C” are given as an example as the contracted product information.

Additionally, contract conditions for each product are managed per customer code, or in other words, per customer. In the present exemplary embodiment, “✓” is displayed for products that the customer has contracted, while the field is left blank (denoted with “-” (dash) in the diagram) for products that the customer has not contracted.

The product information 500 is provided with a “Product Name” field indicating the name of the product, a “Function Name” field indicating the name of a function executable by the product, and a “Process Name” field. Additionally, the product information 500 associates product names, function names, and process names.

In the example illustrated in FIG. 6, “Product A” is illustrated as having a product function called “Function a1” and a product function called “Function a2”. Additionally, “FXDocCreatorClient.exe” is associated as the process name with “Function a1”, and “Dwviewer.exe” is associated as the process name with “Function a2”.

Also, “Product B” is illustrated as having a product function called “Function b1” and a product function called “Function b2”. Additionally, “Wfdw.exe” is associated as the process name with “Function b1”, and “WF.exe” is associated as the process name with “Function b2”.

Also, “Product C” is illustrated as having a product function called “Function c1”. Additionally, “Docushare.exe” is associated as the process name with “Function c1”.

(Topic/Proposal Specification Unit 33)

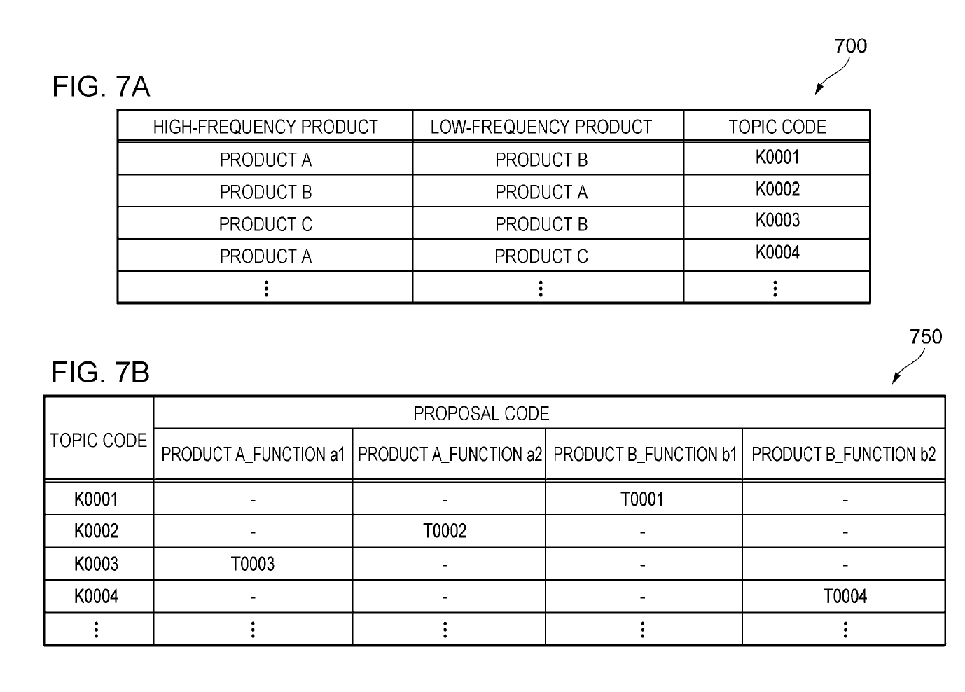

FIG. 7 is a diagram illustrating an example of topic extraction information 700 and topic/proposal combination information 750 according to the present exemplary embodiment.

The topic/proposal specification unit 33 specifies a topic related to the usage of a product by a customer on the basis of information related to the product usage frequency acquired from the frequency specification unit 32. Additionally, the topic/proposal specification unit 33 specifies proposal content for a customer related to usage of a product, on the basis of the information related to the product usage frequency.

In the present exemplary embodiment, the topic/proposal specification unit 33 stores topic extraction information 700 for specifying a topic related to the usage of a product, and topic/proposal combination information 750 for specifying proposal content based on the topic.

The topic extraction information 700 is provided with a “High-frequency Product” field that indicates a product with a high usage frequency, a “Low-frequency Product” field that indicates a product with a low usage frequency, and a “Topic Code” field that specifies a topic code. Additionally, high-frequency products, low-frequency products, and topic codes are associated with each other.

In the example illustrated in FIG. 7A, the topic code “K0001” is associated with the combination of the high-frequency product “Product A” and the low-frequency product “Product B”. Similarly, each topic code is associated with a combination of a high-frequency product and a low-frequency product.

In the information processing system 1 according to the present exemplary embodiment, by discovering a topic regarding the usage of products by a customer on the basis of a high-frequency product and a low-frequency product, the reality of the usage conditions of the products by the customer is grasped more fully. In other words, for a low-frequency product (function), for example, a customer topic associated with a lack of usage of the product (function) becomes apparent more readily. On the other hand, for a high-frequency product (function), a customer's usage of the product (function) with high frequency conversely indicates that the customer is using the specific product (function) disproportionately. Additionally, in the information processing system 1 according to the present exemplary embodiment, a topic is specified on the basis of the perspectives of the low-frequency product and a high-frequency product by which the reality of the usage conditions of the customer is more apparent.

The topic/proposal combination information 750 is provided with a “Topic Code” field and a “Proposal Code” field that indicates a code of proposal content. In the present exemplary embodiment, a proposal code is prepared for each function of a product.

In the example illustrated in FIG. 7B, the proposal code “T0001” related to the function bl of the product B is specified with respect to the topic code “K0001”, for example. Similarly, corresponding proposal codes are specified with respect to the other topic codes.

In the information processing system 1 according to the present exemplary embodiment, by proposing the usage of products based on the combination of a high-frequency product and a low-frequency product, cancellation of the contract for the low-frequency product is reduced, for example. In other words, in the case in which the customer has grasped that a low-frequency product exists, the customer may want to cancel the contract for the low-frequency product. On the other hand, by making a proposal to the customer in which the low-frequency product is combined with a high-frequency product that the customer uses frequently, the low-frequency product is utilized more readily. In this way, in the information processing system 1, the possibility of contract cancellation for a low-frequency product is reduced.

(Template Specification Unit 34)

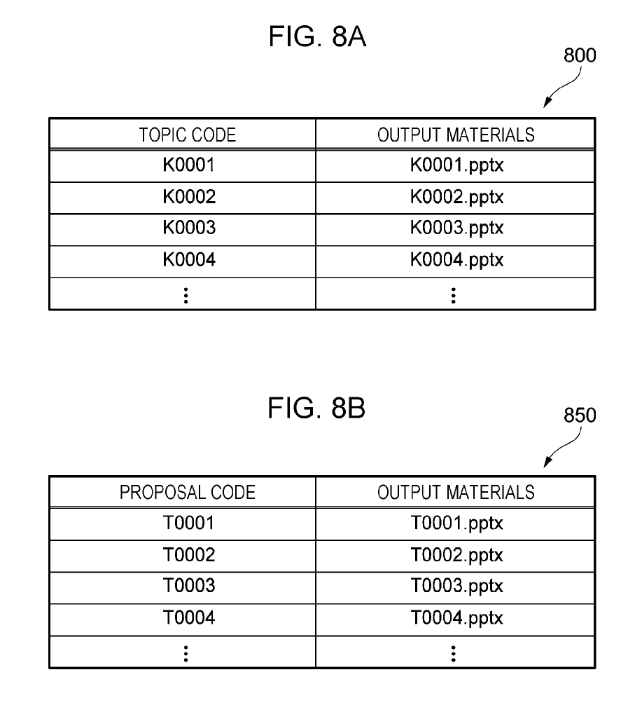

FIGS. 8A and 8B are diagrams illustrating an example of a topic template list 800 and a proposal content template list 850 according to the present exemplary embodiment.

The template specification unit 34 extracts a topic template for creating materials to explain the specified topic to the customer. Specifically, a topic template includes a written scenario for systematically explaining a topic to a customer, including the specification of the usage conditions of products contracted by the customer and the specification of a topic anticipated from the usage conditions of products by the customer.

Additionally, the template specification unit 34 extracts a proposal content template for creating materials to explain the specified proposal content to the customer. Specifically, a proposal content template includes a written scenario for systematically explaining a proposal related to the utilization of already-contracted products, and furthermore an explanation of the content of the contracted products, to the customer.

In the present exemplary embodiment, the template specification unit 34 stores a topic template list 800 that associates topic codes with topic template materials, and a proposal content template list 850 that associates proposal codes with proposal content template materials.

As illustrated in FIG. 8A, the topic template list 800 is provided with a “Topic Code” field and an “Output Materials” field that specifies a topic template.

In this example, the output material “K0001.pptx” is specified with respect to the topic code “K0001”, for example. Similarly, corresponding output materials are specified with respect to the other topic codes.

As illustrated in FIG. 8B, the proposal content template list 850 is provided with a “Proposal Code” field and an “Output Materials” field that specifies a proposal content template.

In this example, the output material “T0001.pptx” is specified with respect to the proposal code “T0001”, for example. Similarly, corresponding output materials are specified with respect to the other proposal codes.

(Proposal Document Creation Unit 35)

The proposal document creation unit 35 merges the output materials related to the specified topic and the output materials related to the proposal to create a proposal document for each customer. Subsequently, the proposal document creation unit 35 transmits the created materials to the user terminal apparatus 10.

(Operations of Information Processing System 1)

Operations of the information processing system 1 configured as above will be described. Hereinafter, operations in each customer terminal apparatus 20 and operations in the server apparatus 30 will be described in order.

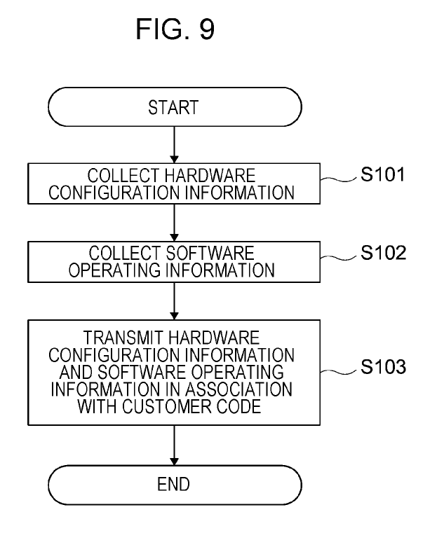

FIG. 9 is an example of an operational flowchart of the customer terminal apparatus 20 according to the present exemplary embodiment.

As illustrated in FIG. 9, in each of the customer terminal apparatus 20, the HW information collection unit 21 collects the host name as hardware configuration information about that customer terminal apparatus 20 (S101). Also, in each of the customer terminal apparatus 20, the HW information collection unit 21 collects process names, CPU times, and process start times as software operating information (S102).

Subsequently, each customer terminal apparatus 20 transmits collected information associating the customer code with the hardware configuration information and the software operating information to the server apparatus 30 (S103).

Note that in the present exemplary embodiment, the above processes from S101 to S103 are executed repeatedly on a predetermined time interval (for example, every few hours).

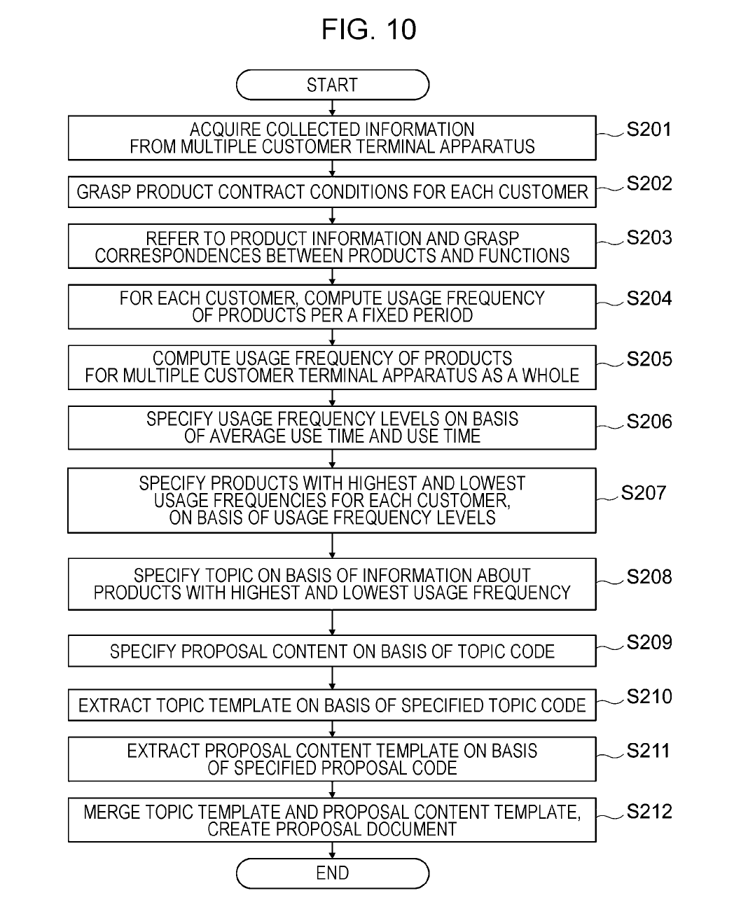

FIG. 10 is an example of an operational flowchart of the server apparatus 30 according to the present exemplary embodiment.

As illustrated in FIG. 10, in the server apparatus 30, the collected information acquisition unit 31 acquires collected information from the multiple customer terminal apparatus 20 (S201). The collected information is managed as the collected information list 300 (see FIG. 4). In the collected information list 300, information about each process is accumulated in units from the start to the end of each process for each customer code.

Additionally, in the server apparatus 30, the frequency specification unit 32 grasps, on the basis of the customer contract information 400 (see FIG. 5), the product contract conditions for each customer (S202). Also, in the server apparatus 30, the frequency specification unit 32 grasps, on the basis of the product information 500 (see FIG. 6), correspondences between products and functions (S203).

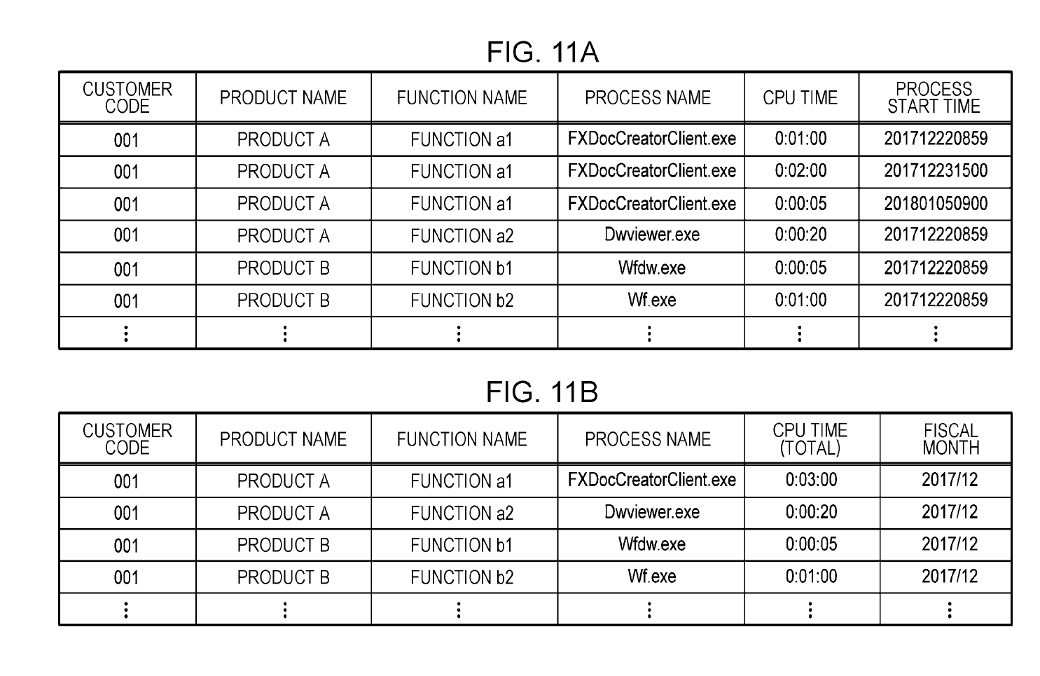

FIGS. 11A and 11B are explanatory diagrams regarding the computation of product usage frequency according to the present exemplary embodiment.

After that, as illustrated in FIG. 10, in the server apparatus 30, the frequency specification unit 32 computes the product usage frequency per a fixed period (for example, monthly) for each customer (S204).

As illustrated in FIG. 11A, for example, collected information about the customer with the customer code “001” is acquired. Additionally, as illustrated in FIG. 11B, by grouping the same process names in the same month, the frequency specification unit 32 computes the total CPU time of each process name (function) per month, for example. Note that to group process names per month, the month is specified from the information about the process start times. In the present exemplary embodiment, the frequency specification unit 32 computes the total use time in one month for each process name (function).

On the other hand, as illustrated in FIG. 10, in the server apparatus 30, the frequency specification unit 32 computes the usage frequency of products for multiple customer terminal apparatus 20 as a whole (S205).

As described above, in the server apparatus 30, the collected information list 300 (see FIG. 4) that collects the collected information from multiple customer terminal apparatus 20 is acquired. Additionally, the frequency specification unit 32 computes, for all customers, the total CPU time per month, for example, of a process name (function) for each process name irrespective of customer.

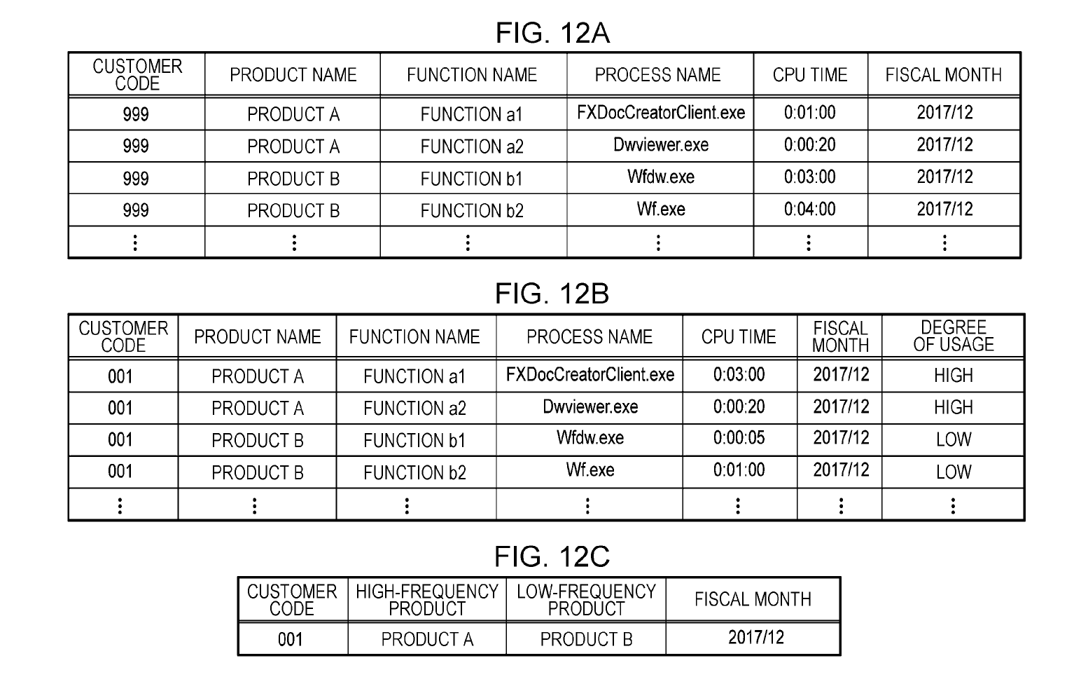

FIGS. 12A, 12B, and 12C are explanatory diagrams regarding the computation of product usage frequency according to the present exemplary embodiment.

Subsequently, as illustrated in FIG. 12A, the frequency specification unit 32 divides the total CPU time of each process name by the number of customer codes to thereby compute an average use time for each process name (function) with regard to all customer terminal apparatus 20. In the present exemplary embodiment, the frequency specification unit 32 computes the average use time in one month for each process name (function) with regard to all customers. Note that in the example of FIG. 12A, the customer code “999” is displayed in the case of grouping multiple customer terminal apparatus 20.

Additionally, as illustrated in FIG. 10, in the server apparatus 30, the frequency specification unit 32 specifies a usage frequency level for each function of the products of the customers, on the basis of the average use time for each function of the products overall and the use time of the functions of the products for each customer (S206). In other words, for each product (function) of a customer, the server apparatus 30 quantitatively specifies the usage conditions of the product (function) on the basis of the usage frequency (software process operating conditions) of a function of each product contracted by the user.

As illustrated in FIG. 12B, for example, the use time in one month of the function al of the product A by the customer with the customer code “001” is longer than the average use time in one month of the function al of the product A by all customers. From the above, the frequency specification unit 32 determines that the usage frequency of the function al of the product A by the customer with the customer code “001” is high.

In this way, the frequency specification unit 32 determines that the usage frequency is high for a product (function) in which the use time is equal to or greater than the average use time. Also, in the case in which there are multiple products (functions) having a high use frequency, from among the products (function) having a high usage frequency, the frequency specification unit 32 raises the priority of the usage frequency of a product (function) with a large difference between the average use time and the use time, and lowers the priority of the usage frequency of a product (function) with a small difference between the average use time and the use time.

On the other hand, as illustrated in FIG. 12B, for example, the use time in one month of the function b1 of the product B by the customer with the customer code “001” is shorter than the average use time in one month of the function b1 of the product B by all customers. From the above, the frequency specification unit 32 determines that the usage frequency of the function b1 by the customer with the customer code “001” is low.

In this way, the frequency specification unit 32 determines that the usage frequency is low for a product (function) in which the use time falls below the average use time. Also, in the case in which there are multiple products (functions) having a low use frequency, from among the products (function) having a low usage frequency, the frequency specification unit 32 raises the priority of the usage frequency of a product (function) with a small difference between the average use time and the use time, and lowers the priority of the usage frequency of a product (function) with a large difference between the average use time and the use time.

Furthermore, as illustrated in FIG. 10, in the server apparatus 30, the frequency specification unit 32 specifies the product with the highest usage frequency and the product with the lowest usage frequency for each customer, on the basis of the usage frequency level specified for each function of the products of the customer (S207).

In the present exemplary embodiment, the frequency specification unit 32 combines the usage frequency levels of the functions of products to specify the usage frequency in units of products. For example, for the customer with the customer code “001”, the usage frequency of the product A is specified as high, while the usage frequency of the product B is specified as low.

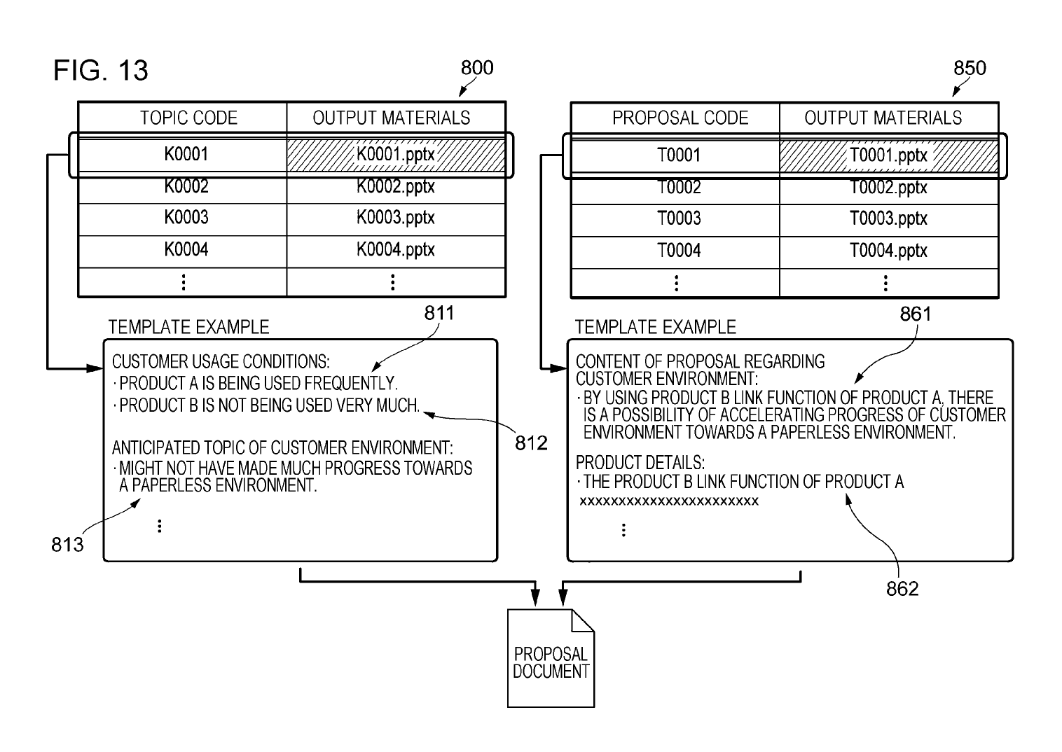

FIG. 13 is an explanatory diagram of a specific example of topic and proposal content according to the present exemplary embodiment.

Subsequently, as illustrated in FIG. 10, in the server apparatus 30, the topic/proposal specification unit 33 specifies a topic on the basis of information about the product with the highest usage frequency and the product with the lowest usage frequency (S208).

In this example, the usage frequency of the product A is specified as high, while the usage frequency of the product B is specified as low. Consequently, the topic/proposal specification unit 33 specifies the corresponding topic code “K0001” on the basis of the topic extraction information 700 (see FIG. 7A).

Furthermore, in the server apparatus 30, the topic/proposal specification unit 33 specifies proposal content on the basis of the topic code (S209).

Specifically, the topic/proposal specification unit 33 specifies the corresponding proposal code “T0001” on the basis of the topic/proposal combination information 750 (see FIG. 7B).

Additionally, in the server apparatus 30, the template specification unit 34 extracts a topic template on the basis of the specified topic code (S210).

As illustrated in FIG. 13, the template specification unit 34 extracts the output materials “K0001.pptx” of the topic template corresponding to the topic code “K0001” on the basis of the topic template list 800.

With regard to the usage conditions of products contracted by the customer, for example, the output materials of the topic template include comments 811 related to products with a high usage frequency, and comments 812 related to products with a low usage frequency. Also, the output materials of the topic template include comments 813 related to an anticipated topic for the customer.

Furthermore, as illustrated in FIG. 10, in the server apparatus 30, the template specification unit 34 extracts a proposal content template on the basis of the specified proposal code (S211).

As illustrated in FIG. 13, the template specification unit 34 extracts “T0001.pptx” as the output materials of the proposal content template corresponding to the topic code “K0001” on the basis of the proposal content template list 850.

The output materials of the proposal content template include comments 861 related to proposal content for the customer and a product description 862 related to a product (function) that achieves the proposal content, for example.

Additionally, as illustrated in FIG. 10, in the server apparatus 30, the topic template and the proposal content template are merged to create a proposal document (S212).

Note that in the description of the present exemplary embodiment, an example in which the proposal document includes a topic and proposal content is described, but the information included in the proposal document is not limited to this information. For example, the proposal document may also include a cover stating the title of the proposal document, the customer name, or the like, and various content such as case information about product use cases and the like.

Subsequently, the created proposal document is downloaded to the user terminal apparatus 10 and checked on a screen by the user, or printed out and read by the user and the like, for example.

As above, in the information processing system 1 according to the present exemplary embodiment, a proposal regarding the usage of a product is made to a customer after a product contract has been made.

Particularly, in the past, creating a proposal document about a topic and proposal content related to the usage of products contracted by a customer largely has depended on the knowledge and experience of a user such as a sales manager, for example, and the accuracy of extracting an appropriate scenario has been inconsistent depending on the user.

In contrast, in the information processing system 1 according to the present exemplary embodiment, a proposal document (topic and proposal content templates) for a customer product specified on the basis of the actual usage conditions of the product is created automatically. Consequently, in the case of providing support (follow-up) to a customer after a product contract has been made, the burden when extracting a customer (product) about which to make a proposal is reduced. Also, in the case in which a user such as a sales manager provides support (follow-up) to a customer after a product contract has been made, the burden of creating a scenario about a topic related to the usage of the product by the customer and a proposal related to the usage of the product is reduced.

Note that in the case in which the customer has not used a specific product at all over a fixed period, for example, there is a possibility that the process name itself of the product (function) may not be revealed in the software operating information. In contrast, in the present exemplary embodiment, the server apparatus 30 grasps all products contracted by a customer on the basis of the customer contract information 400. Consequently, from among the products contracted by a customer obtained from the customer contract information 400, the frequency specification unit 32 determines that a product (function) not obtained as a process name in the software operating information is a low-frequency product (the usage frequency is zero).

Also, in the present exemplary embodiment, a topic and proposal content are specified on the basis of the usage frequency in units of products, but the configuration is not limited to this example. For example, in the information processing system 1, a topic and proposal content may also be specified in units of functions of products. In this case, topics related to the usage of products by customers are analyzed in greater detail, and proposals to customers have more specific content.

Note that in the description of the present exemplary embodiment, the usage frequency of a product (function) is computed on the basis of the length of CPU time (use time) related to the process name corresponding to the function of the product, but the configuration is not limited to this example. For example, the usage frequency of a product (function) may also be specified on the basis of the number of times the product (function) is used during a fixed period, for example, irrespectively of the CPU time.

Furthermore, in the information processing system 1 according to the present exemplary embodiment, the usage conditions of a product are specified on the basis of the usage frequency of the product, but the configuration is not limited to this example. For example, the SW information collection unit 22 may also specify the usage conditions of a product on the basis of the amount of data (number of bytes) in the information handled by the product. In this case, when the amount of data in the information transmitted and received by the target product, the amount of data in the information saved by the target product, or the like is relatively large, the usage of the product is determined to be notable. On the other hand, when the amount of data in the information transmitted and received by the target product, the amount of data in the information saved by the target product, or the like is relatively small, the usage of the product is determined to be sluggish.

Note that in the information processing system 1 according to the present exemplary embodiment, an example of using a product (software) used by the customer terminal apparatus 20 as the target of the collected information is used, but the configuration is not limited thereto. For example, on the basis of collected information about a product (software) used in multi-function device that unifies the functions of a copier, a printer, a scanner, a facsimile machine, and the like, the information processing system 1 may make a proposal and the like to a customer who uses the multi-function device.

Furthermore, on the basis of operating information about application software products used over a network such as the Internet, the information processing system 1 according to the present exemplary embodiment may make a proposal and the like to a customer who uses the application.

Herein, in the case of a web application, the application runs by cooperation between a program that runs on a web browser of the customer terminal apparatus 20 and a program on a web server apparatus. For this reason, in the case in which a web application is the target product, in the operating information, the web browser is revealed as the process name, and information about the CPU time is obtained as the process time of the web browser.

Accordingly, in the information processing system 1 according to the present exemplary embodiment, in the case in which a web application is the product about which to make a proposal, the usage conditions of the product are specified on the basis of web access information such as the Uniform Resource Locator (URL) referenced during the web access, for example. Additionally, in the information processing system 1, the web application is specified and the usage frequency or the like is grasped on the basis of the accessed resource specified by the URL, for example.

Next, a hardware configuration of the user terminal apparatus 10, the customer terminal apparatus 20, and the server apparatus 30 according to the present exemplary embodiment will be described.

Each of the user terminal apparatus 10, the customer terminal apparatus 20, and the server apparatus 30 according to the present exemplary embodiment is provided with a central processing unit (CPU) that acts as a computational component, memory that acts as a main memory component, a magnetic disk apparatus (hard disk drive (HDD)), a network interface, a display function that includes a display, a sound function, input devices such as a keyboard and mouse, and the like.

Additionally, the magnetic disk apparatus stores OS programs and application programs. Additionally, by having the CPU execute these programs loaded into the memory, the function of each functional unit in each of the user terminal apparatus 10, the customer terminal apparatus 20, and the server apparatus 30 according to the present exemplary embodiment is realized.

Furthermore, a program that causes the series of operations in the information processing system 1 according to the present exemplary embodiment to be realized in the customer terminal apparatus 20 and the server apparatus 30 obviously may be provided by a communication medium, for example, and may also be provided by being stored on any of various types of recording media.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising:
a collector that collects, from a terminal apparatus of a customer, operating information related to an operation of a function of a product contracted by the customer and used on the terminal apparatus;
a specification unit that specifies a usage condition of the product on a basis of the collected operating information; and
a creator that creates proposal information related to a proposal regarding usage of the product to the customer, on a basis of the usage condition.

2. The information processing system according to claim 1, wherein
the creator creates the proposal information on a basis of a usage frequency of the product by the customer.

3. The information processing system according to claim 2, wherein
the creator creates the proposal information that includes combination information related a usage combining a product having a relatively high usage frequency with a product having a relatively low usage frequency.

4. The information processing system according to claim 2, wherein
the specification unit specifies the usage frequency of the product on a basis of contract information regarding the product contracted by the customer.

5. The information processing system according to claim 1, wherein
the creator specifies a topic of the customer related to use of the product on a basis of the usage condition, and creates the proposal information corresponding to the specified topic.

6. The information processing system according to claim 5, wherein
the creator creates the proposal information using a template selected from among a plurality of templates stating proposals to customers in advance, on a basis of the specified topic.

7. The information processing system according to claim 1, wherein
the specification unit specifies the usage condition of the product on a basis of web access information regarding the customer.

8. An information processing apparatus comprising:
a specification unit that specifies a usage condition of a product contracted by a customer and used on a terminal apparatus of the customer, on a basis of operating information related to an operation of a function of the product; and
a creator that creates proposal information related to a proposal regarding usage of the product to the customer, on a basis of the usage condition.

9. A non-transitory computer readable medium storing a program causing a computer to execute a process for processing information, the process comprising:
specifying a usage condition of a product contracted by a customer and used on a terminal apparatus of the customer, on a basis of operating information related to an operation of a function of the product; and
creating proposal information related to a proposal regarding usage of the product to the customer, on a basis of the usage condition.
